(19) United States
(12) Patent Application Publication
(10) Pub. No.: US 2008/0229255 A1
(43) Pub. Date: Sep. 18, 2008

(54) Apparatus, method and system for gesture detection

(75) Inventors: Jukka Linjama, Espoo (FI); Kalle Pikkujamsa, Oulu (FI)

Correspondence Address: WARE FRESSOLA VAN DER SLUYS & ADOLPHSON, LLP, BRADFORD GREEN, BUILDING 5, 755 MAIN STREET, P O BOX 224, MONROE, CT, 06468, US

(73) Assignee: NOKIA CORPORATION

(21) Appl. No.: 11/725,169

(22) Filed: Mar. 15, 2007

(51) Int. Cl. G06F 3/03

(52) U.S. Cl. 715/863

(57) ABSTRACT

Apparatuses, methods, and computer program products are provided to sense orientations or sequence of orientations, i.e. gestures, of mobile devices. The orientation or sequence of orientations control components and/or functions of the mobile device. Indications may be provided to a user to inform the user that the mobile device is in a particular orientation, or that the user has successfully performed a sequence of orientations corresponding to a functionality of the mobile device. The orientation or sequence of orientations may be performed while the mobile device is in a locked or idle state in order to control components and/or functions of the mobile device. A low energy sensor may activate the mobile device after a particular orientation is achieved.

### BACKGROUND OF THE INVENTION

1. Technical Field

The present invention relates to user interface and control of mobile devices.

2. Related Art

Mobile devices, such as mobile terminals used in communications over telecommunication networks, are being implemented with greater and greater functionality. For example, mobile terminals may be used for gaming, as clocks or alarm clocks, and other functions. Generally the functions of a mobile terminal are controlled by a user input device, for example a keypad or softkeys. However, often times the input device may be locked to prevent inadvertent contact with the mobile terminal from activating functions of the terminal. When the input device of a mobile terminal is locked, in order to use any of the functions of the mobile terminal, a user must first unlock the input device, by pressing a sequence of keys or the like. It may be desirable to allow use of the functionality of the mobile terminal without the need for unlocking the input device.

While the input device may be locked and unlocked or functions of the mobile terminal activated and de-activated when the mobile terminal is moved in some manner, continuously activating and de-activating of the mobile terminal results in high power consumption. Due to the mobile nature of mobile terminals they are often subject to continuous movement, leading to unintentional activation of functions in mobile terminals employing motion detecting activation mechanisms. The activation of functions of the mobile terminals consumes the power source of the mobile terminals, which may be limited.

Furthermore, there may be various operations of the mobile terminal that cannot be performed while the mobile terminal is in a locked or idle state. In order to perform the operations the mobile terminal must be unlocked, and the entire system of the mobile terminal must be activated. Unlocking and activating the mobile terminal for a quick task, such as looking at the time, will consume a relatively large amount of power compared to the complexity of the task. In addition, unlocking of mobile terminals generally requires actuating a particular combination of keys in a specific order. Unlocking the mobile terminal by actuating keys may be time consuming relative to the task that the user wishes to perform, i.e. illuminate the display to check the time on a clock of the mobile terminal. Therefore, there is a need for gesture recognition that provides reliable detection of user intent, and allows the user to perform operations of the mobile terminal without activating the entire system of the mobile terminal.

### SUMMARY OF THE INVENTION

In order to overcome the limitations associated with mobile devices mentioned above, apparatuses, methods, and computer program products are provided to sense orientations or sequence of orientations, i.e. gestures, of mobile devices. For example, an orientation may include orienting the mobile device face down for a half second to two seconds, and a sequence of orientations may include face down for a period of time followed by turning the mobile device face up. The orientation or sequence of orientations control components and/or functions of the mobile device. Indications may be provided to a user to inform the user that the mobile device is in a particular orientation, or that the user has successfully performed a sequence of orientations corresponding to a functionality of the mobile device. The orientation or sequence of orientations may be performed while the mobile device is in a locked or idle state in order to control components and/or functions of the mobile device. A low energy sensor may activate the mobile device after a particular orientation is achieved.

In a first aspect of the invention, an apparatus is provided and may include a sensor configured to sense at least a first orientation and a second orientation of the apparatus and provide a first signal indicative of the first orientation and a second signal indicative of the second orientation and a gesture detector, responsive to the first signal and the second signal, for providing a control signal based at least on the first predetermined orientation and the second predetermined orientation.

In accordance with the first aspect of the invention, the control signal may be configured to activate at least a first component of the apparatus.

In accordance with the first aspect of the invention, the control signal may be configured to deactivate at least a first component of the apparatus.

In accordance with the first aspect of the invention, the first component may be a light for illuminating a display of the apparatus.

The apparatus according to the first aspect of the invention may include an indicator, responsive to the control signal, for providing an indication representing at least the first predetermined orientation.

The apparatus according to the first aspect of the invention may include a motion sensor configured to provide information related to the movement of the apparatus.

In accordance with the first aspect of the invention, the gesture detector may be further responsive to the information related to the movement of the apparatus for providing the control signal additionally based on the information related to the movement of the apparatus.

In accordance with the first aspect of the invention, the sensor comprises at least one gravity sensing device.

In accordance with the first aspect of the invention, the sensor comprises a low-power sensor.

In accordance with the first aspect of the invention, the gesture detector may be configured to provide the control signal when the apparatus is in an idle state.

In accordance with the first aspect of the invention, the first orientation and the second orientation comprise a predefined gesture.

In accordance with the first aspect of the invention, at least the predefined gesture is user determined.

In accordance with the first aspect of the invention, the sensor comprises at least one tilt sensor.

In accordance with the first aspect of the invention, the motion sensor comprises at least one accelerometer.

In accordance with the first aspect of the invention, at least the first component is activated by the control signal when at least one user-input device of the apparatus is inactivated.

The apparatus according to the first aspect of the invention comprises a mobile terminal device.

The apparatus according to the first aspect of the invention, may further include a transceiver configured for radio frequency communication.

The apparatus according to the first aspect of the invention, may further include a controller responsive to the control signal configured to control at least a first component of the apparatus.

In a second aspect of the invention, a method is provided that may include providing a first signal indicative of a first orientation of a mobile device to a gesture detector, providing a second signal indicative of a second orientation of the mobile device to said gesture detector, and providing a control signal based at least on the first signal and the second signal.

The method according to the second aspect of the invention may further include providing at least a movement signal indicative of at least a first movement of the mobile device.

In accordance with the second aspect of the invention, the control signal may be configured to activate at least a first component of the mobile device.

In accordance with the second aspect of the invention, the first component may be a light for illuminating a display of the mobile device.

In accordance with the second aspect of the invention, the control signal may be configured to deactivate at least a first component of the mobile device.

In accordance with the second aspect of the invention, the first orientation and the second orientation may comprise a predefined gesture.

In accordance with the second aspect of the invention, the predefined gesture may be user defined.

In accordance with the second aspect of the invention, the control signal may be based at least in part on the movement signal.

In accordance with the second aspect of the invention, the control signal may be provided during an idle-state of the mobile device.

In accordance with the second aspect of the invention, the control signal may be provided when at least one user input device of the mobile device is inactivated.

The method according to the second aspect of the invention may further include detecting the first orientation of the mobile device, and detecting the second orientation of the mobile device.

The method according to the second aspect of the invention, may further include providing an indication to a user of the mobile device based at least in part on the control signal, the indication may correspond to at least the first orientation of the mobile device.

In a third aspect of the invention a computer program product comprising a computer readable storage structure embodying computer program code thereon for execution by a computer processor, wherein the computer program code comprising instructions for performing a method comprising providing a first signal indicative of a first orientation of a mobile device, providing a second signal indicative of a second orientation of the mobile device, and providing a control signal based at least one the first signal and the second signal is provided

### BRIEF DESCRIPTION OF THE DRAWINGS

Having thus described the invention in general terms, reference will now be made to the accompanying drawings, which are not necessarily drawn to scale, where:

FIG. 1 is a block diagram of a mobile terminal in accordance with an embodiment of the invention.

FIG. 2 is a flowchart illustrating exemplary steps in a method for controlling the functionality of a mobile terminal by predefined gestures.

### DETAILED DESCRIPTION

The present invention now will be described more fully hereinafter with reference to the accompanying figures, in which exemplary embodiments of the invention are shown. The invention may, however, be embodied in many different forms and should not be construed as limited to the embodiments set forth herein. Like reference numerals refer to like elements throughout.

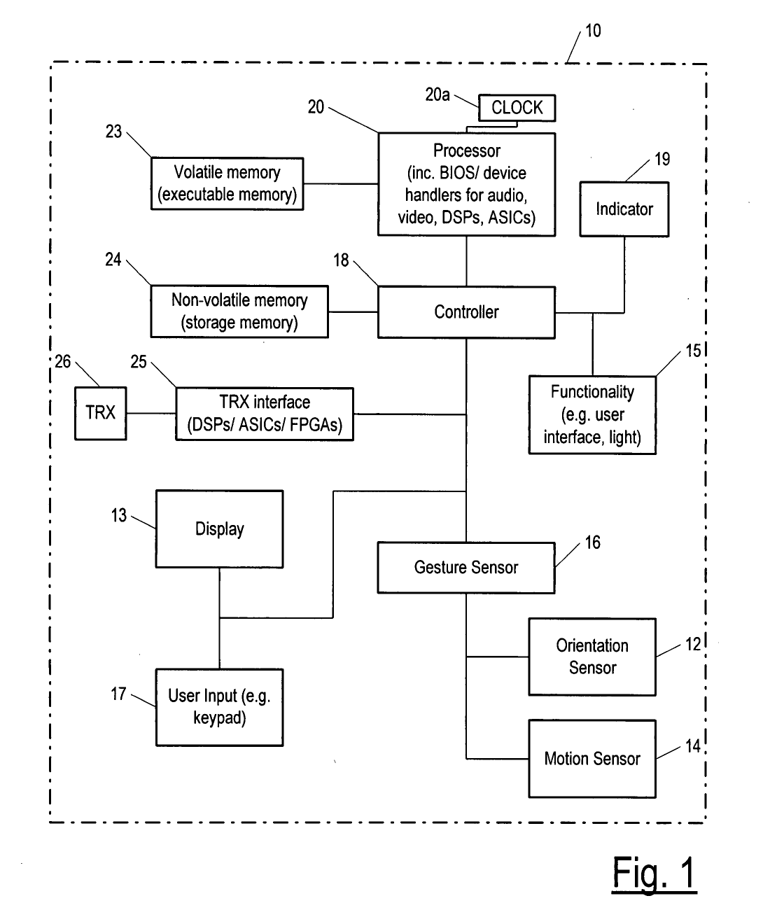

FIG. 1 shows an exemplary embodiment of the invention as a mobile terminal 10. The mobile terminal 10 may be a cellular telephone device, which may include other devices, or the mobile terminal may be any other mobile device, such as a personal data assistant (PDA), pager, laptop computer, or the like. The mobile terminal 10 may include a transceiver 26 for effecting communication over a telecommunications network or networks, as are known to one of skill in the art. The mobile terminal may also include a transceiver interface 25. The mobile terminal 10 may also include a display 13, i.e. a screen, that is configured to provide representations of the operations and functions performed by the mobile terminal. The mobile terminal 10 may also include a user input 17, such as a keypad or control key, to allow a user to control the operations and functions of the mobile terminal 10. Although the display 13 and user input 17 are shown in FIG. 1 as distinct elements, it is understood that the display 13 and user input 17 may comprise a single component of the mobile terminal, for example a screen with softkeys. Additionally, the mobile terminal 10 may include an orientation sensor 12. The orientation sensor 12 is configured to sense the orientation of the mobile terminal 12, and to provide signals that may be used to determine if a gesture has been made with respect to the mobile terminal 10.

As used in the present application, gesture means a motion and/or movement or combination of motions and/or movements, including but not limited to motions or movements that result in a particular orientation or orientations of a device for more than a transitory period of time. In exemplary embodiments of the present invention gestures or combinations of gestures may be used to perform various functions and/or activate or deactivate various components of the mobile terminal 10. The gestures may be preset or user defined. If the gestures are user defined, the mobile terminal 10 may include devices for recording and storing the user defined gestures, and for correlating the user defined gestures to control functions and/or activation or deactivation of components of the mobile terminal 10.

The orientation sensor 12 may include one or more devices that are acted upon by gravity in order to provide a signal or signals that indicate in which direction gravity is acting upon the device or devices. For example, the orientation sensor 12 may include one or more tilt sensors on one or more perpendicular axis. One tilt sensor may be positioned on the X-axis, one on the Y-axis, and one on the Z-axis. However, it is understood that the orientation sensor 12 does not need to be able to provide information from all three axis, as it may be sufficient for the present invention for the orientation sensor 12 to provide information from one axis. The orientation sensor 12 may be configured such that is provides information regarding the orientation of the mobile terminal 10 relative to one or more display devices 13 or user inputs 17.

For example, the orientation sensor 12 may be configured so that it is able to provide a signal when the display 13 of the mobile terminal 10 is facing substantially down, i.e. towards the direction of gravity, and a signal when the display 13 of the mobile terminal 10 is facing substantially upwards, i.e. away from the direction of gravity. It is also understood that the orientation sensor 12 may be comprised of one or more acceleration sensors, either alone or in combination with other sensors, such as tilt or other motion sensors. It is also understood that the orientation sensor 12 may be configured to provide signals indicative of the orientation of the mobile terminal 10 when the mobile terminal 10 is in particular orientations and not others. In this manner, it may be possible to reduce the signaling and thus the power consumption of the mobile terminal 10. Additionally or alternatively, the orientation sensor 10 may be a low energy sensor, for example one that only provides a signal indicative of the orientation approximately once every 300 milliseconds (ms) or 3 Hz.

The mobile terminal 10 may also include a gesture detector 16 that receives signals from the orientation sensor 12, and determines whether a predefined gesture has been made. For example, the gesture detector 16 may receive a signal indicative of a first orientation and a signal indicative of a second orientation of the mobile terminal 10 from the orientation sensor 12. The gesture detector 16 may be configured to determine that the signals are indicative of a particular predefined gesture. The gesture detector 16 is configured to provide a control signal to a controller 18 when the gesture detector 16 determines that a predefined gesture has occurred. The controller 18 is coupled to a processor 20 of the mobile terminal 10, to non-volatile memory 24 and volatile memory 23 as well. The controller 18 either by itself or in conjunction with the processor 20 is responsible for carrying out the functions, i.e. controlling the components, of the mobile terminal 10. When the controller 18 receives a signal from the gesture detector 16 indicating a predefined gesture has occurred, the controller 18 is configured to determine which function the predefined gesture corresponds to, and activate or inactivate that function of the mobile terminal 10. It is understood that the control signal from the gesture detector 16 may activate or inactivate one or more functions 15 of the mobile terminal 10. A predefined gesture may be used to control one or more functions of the mobile terminal in the following manner.

In an exemplary embodiment of the present invention, the preset or user defined gesture, i.e. predefined gesture, may include turning mobile terminal 10 to face downwards for a certain period of time, i.e. one or two seconds, and then turning the mobile terminal 10 to face upwards. In this example, when the mobile terminal 10 is in a downward orientation, the orientation sensor 12 provides a signal to the gesture detector 16 indicating that the mobile terminal 10 is oriented downward. If the mobile terminal 10 remains oriented downward, the next time the orientation sensor 12 samples the orientation of the mobile terminal it will again provide a signal to the gesture detector 16 indicating that the mobile terminal 10 is oriented downward. The gesture detector 16 receives the signals from the orientation sensor 12 and provides control signals to the controller 18 based on the received signals. In this exemplary embodiment, two consecutive signals indicating that the mobile terminal 10 is facing downwards within a particular period of time, i.e. two seconds, are identified by the gesture detector 16 to correspond to a particular predefined gesture. Therefore, the gesture detector 16 will provide a control signal based on the determined predefined gesture.

The control signals may be related to the timing and sequence of signals received from the orientation sensor 12. For example, in the exemplary situation discussed above, the gesture detector 16 receives two successive signals indicating the mobile terminal 10 is facing downward. When these successive signals correspond to a defined gesture, the gesture detector 16 provides a control signal corresponding to that defined gesture. In the above example, the signals from the orientation sensor 12 indicate that the mobile terminal has been downward for a certain period of time, and accordingly the gesture detector 16 is configured to provide a control signal corresponding to the orientation of the mobile terminal 10 when the mobile terminal 10 has been downward for a period of time, i.e. one or two seconds. The control signal may activate or inactive a component, i.e. functionality 15, of the mobile terminal 10. For example, the control signal provided in this example may activate a user interface function, i.e. indicator 19, providing an indication to a user that the predefined gesture has occurred. The indication may be a vibration indication, sound indication or visual indication, for example illuminating one or more lights of the mobile terminal, i.e. an indicator 19. It is understood that the indicator 19 of the mobile terminal may be one or more of the components used in the normal functioning of the mobile terminal 10, for example a LED light, a speaker for producing a sound indicating an incoming call or message, or a vibration device used to indicate an incoming call or message when the mobile terminal 10 is in a silent mode.

The detection of the orientation, i.e. gesture, of the mobile terminal 10 may be performed in a locked or idle state of the mobile terminal 10. Thereby allowing a function of the mobile terminal 10 to be performed without unlocking or fully powering up the mobile terminal 10. It is understood that the orientation of the mobile terminal 10, i.e. downwards or upwards, may correspond to a component or components of the mobile terminal 10. For example, the downwards orientation of the mobile terminal 10 may represent the display 13 of the mobile terminal 10 facing in a downwards direction. The orientation of the mobile terminal 10 may also correspond to other visible components of the mobile terminal 10.

It is understood that the gesture discussed above may also be part of another predefined gesture. For example, in another exemplary embodiment of the invention after the user has received the indication, the user may then turn the mobile terminal 10 so that the mobile terminal is facing upwards. The orientation sensor 12 senses that the mobile terminal 10 is facing upwards, and provides a signal to the gesture detector 16 indicating this orientation. When this sequence of orientations corresponds to a predefined gesture, the gesture detector 16 provides a control signal representing this predefined gesture to the controller 18. In this exemplary scenario the predefined gesture comprises the mobile terminal 10 down for one or two seconds, followed by the mobile terminal 10 facing upwards. The control signal may activate or inactive one or more components of the mobile terminal 10. In the present example, the control signal may cause the display to be illuminated for a period of time, i.e. five seconds. The control signal may in addition or alternatively cause an indication, i.e. vibration, audio, visual, to be provided to the user that the predefined gesture has occurred. The indication may be provided by an indicator 19 of the mobile terminal. It is understood that any number, sequence and combinations of gestures comprising various orientations are contemplated by the present invention.

In addition or alternatively to orientations of the mobile terminal, the gestures may also comprise movement, i.e. acceleration, or lack thereof of the mobile terminal. In another exemplary embodiment of the invention, the mobile terminal 10 may further comprise one or more motion sensors 14 that are configured to determine whether the mobile terminal is moving. It is understood that although the motion sensor 14 is presented in FIG. 1 as a separate element from the orientation sensor 12, the motion sensor 14 may be incorporated as a part of the orientation sensor 12, thereby providing a sensor for orientation and motion detection. The motion sensors 14 may provide signals to the gesture detector 16 indicative of whether the mobile terminal is moving. The signals may comprise information related to the direction and magnitude of movement of the mobile terminal. The movement information related signals may be used by the gesture detector 16 either alone, or in combination with signals from the orientation sensor 12, to determine whether a predefined gesture has occurred. For example, the motion sensor 14 may determine that the mobile terminal is substantially stationary, and may provide a signal indicating that the mobile terminal is substantially stationary to the gesture detector 16. At approximately the same time, the gesture detector 16 receives from the orientation sensor 12 a signal or signals indicating that the mobile terminal is in a downward orientation. This combination of substantially stationary and downward orientation may correspond to a predefined gesture, and therefore the gesture detector 16 may provide a control signal indicating that the predefined gesture has occurred to the controller 18. For example, the predefined gesture may correspond to a control signal activation or inactivating one or more of the components, i.e. functionalities of the mobile terminal 10. For example, the control signal for the predefined gesture discussed above may correspond to inactivating the audible sounds of the mobile terminal 10, by placing the mobile terminal 10 in a silent mode.

In another exemplary embodiment of the invention, the predefined gesture may include one or more taps on the mobile terminal 10 followed by turning the mobile terminal 10 to a particular orientation. In this exemplary embodiment of the invention, the predefined gesture may deactivate the audible sound made by the mobile terminal upon receipt of a call or message, i.e. ringing. In this scenario, the user taps the mobile terminal 10 a certain number of times, for example twice. The motion sensor 14 senses the motion of the mobile terminal 10 caused by the taps and sends a signal indicating that the user has tapped the mobile terminal one or more times. The gesture detector 16 receives the signals from the motion sensor 14, and then may receive a signal from the orientation sensor 12 indicating that the mobile terminal is in a display down orientation. In response to these signals, the gesture detector 16 may provide a control signal for controlling the functionality of the mobile terminal 10. In this exemplary embodiment, the control signal mutes the mobile terminal's ringing. The control signal may also activate an indication to the user that the mobile terminal is in the display down orientation.

In another exemplary embodiment of the present invention, the predefined gestures may be carried out while the mobile terminal 10 is in an idle or sleep state. In this manner, the entire mobile terminal system does not need to be powered up in order to perform the function corresponding to the predefined gesture. In addition, the predefined gestures may be performed while one or more user input devices 17, i.e. keypad or keys, is in a locked state. The functions corresponding to the predefined gestures may be performed without unlocking the keys.

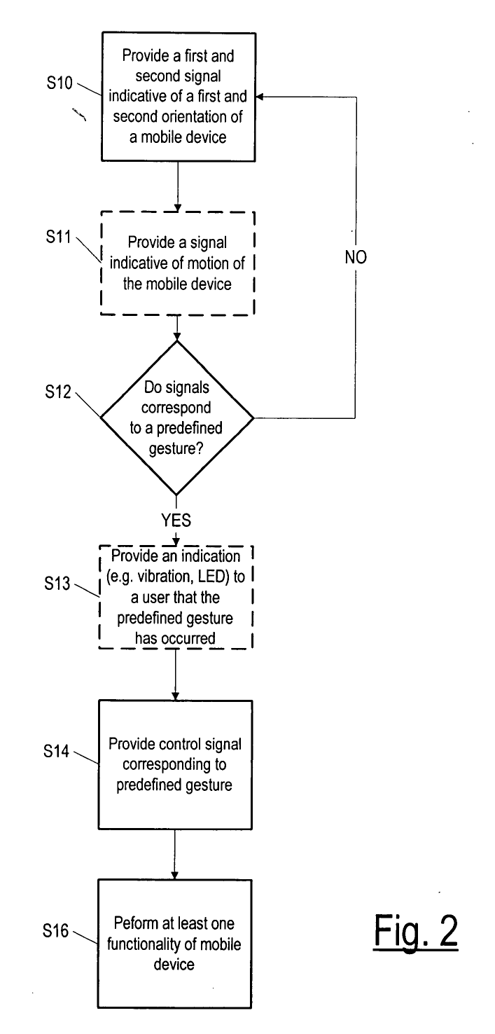

FIG. 2 illustrates various steps in a method for using predefined gestures to control various functions of a mobile terminal. At step S10 a first and second signal indicative of a first and second orientation of a mobile device are provided. The signals may be provided to a gesture detector, and the gesture detector may be a component of the mobile device. At optional step S11 a signal indicative of the motion of the mobile device may also be provided. Similarly, the signal indicator of the motion of the mobile device may be provided to the gesture detector as well. In step S12 it is determined whether the signals correspond to a predefined gesture. If the signals do not correspond to a predefined motion, the method starts over at step S10. If the signals correspond to a predefined motion, at step S14 a control signal is provided, and at step S16 at least one functionality of the mobile device is performed based on the control signal. In optional step S13 an indication, i.e. vibration, light from a light emitting diode (LED), may be provided to a user of the mobile device to inform the user that the predefined gesture has occurred. It is understood that the indication may correspond to a particular predefined gesture, or each various indication may correspond to multiple predefined gestures. It is contemplated that the user may be able to select which indication is used to inform the user that a predefined gesture or gestures have occurred.

An exemplary embodiment of the present invention may also include a computer program product comprising a computer readable storage structure embodying computer program code thereon for execution by a computer processor, wherein the computer program code comprising instructions for performing at least the steps of the method according to the invention discussed above in relation to FIG. 2. It is understood that the above discussed mobile devices, i.e. mobile terminals, methods and computer program products may be implemented in a telecommunications system, and that the above discussed embodiments may include components known to one of skill in the art for implementation in telecommunications systems.

It is to be understood that all of the present figures, and the accompanying narrative discussions of corresponding embodiments, do not purport to be completely rigorous treatments of the method, apparatus, system, and software product under consideration. A person skilled in the art will understand that the steps and signals of the present application represent general cause-and-effect relationships that do not exclude intermediate interactions of various types, and will further understand that the various steps and structures described in this application can be implemented by a variety of different sequences and configurations, using various combinations of hardware and software which need not be further detailed herein. It is to be understood that the above-described arrangements are only illustrative of the application of the principles of the present invention. Numerous modifications and alternative arrangements may be devised by those skilled in the art without departing from the scope of the present invention, and the appended claims are intended to cover such modifications and arrangements.

What is claimed is:

1. An apparatus comprising:
a sensor configured to sense at least a first orientation and a second orientation of said apparatus and provide a first signal indicative of said first orientation and a second signal indicative of said second orientation; and
a gesture detector, responsive to said first signal and said second signal, for providing a control signal based at least on said first predetermined orientation and said second predetermined orientation.

2. The apparatus according to claim 1, wherein said control signal is configured to activate at least a first component of said apparatus.

3. The apparatus according to claim 1, wherein said control signal is configured to deactivate at least a first component of said apparatus.

4. The apparatus according to claim 2, wherein said first component is a light for illuminating a display of said apparatus.

5. The apparatus according to claim 1, further comprising an indicator, responsive to said control signal, for providing an indication representing at least said first predetermined orientation.

6. The apparatus according to claim 1, further comprising a motion sensor configured to provide information related to the movement of said apparatus.

7. The apparatus according to claim 6, wherein said gesture detector is further responsive to said information related to the movement of said apparatus for providing said control signal additionally based on said information related to the movement of said apparatus.

8. The apparatus according to claim 1, wherein said sensor comprises at least one gravity sensing device.

9. The apparatus according to claim 1, wherein said sensor comprises a low-power sensor.

10. The apparatus according to claim 1, wherein said gesture detector is configured to provide said control signal when said apparatus is in an idle state.

11. The apparatus according to claim 1, wherein said first orientation and said second orientation comprise a predefined gesture.

12. The apparatus according to claim 11, wherein at least said predefined gesture is user determined.

13. The apparatus according to claim 1, wherein said sensor comprises at least one tilt sensor.

14. The apparatus according to claim 6, wherein said motion sensor comprises at least one accelerometer.

15. The apparatus according to claim 2, wherein at least said first component is activated by said control signal when at least one user-input device of said apparatus is inactivated.

16. The apparatus according to claim 1, wherein said apparatus comprises a mobile terminal device.

17. The apparatus according to claim 1, further comprising a transceiver configured for radio frequency communication.

18. The apparatus according to claim 1, further comprising a controller responsive to said control signal configured to control at least a first component of said apparatus.

19. A method, comprising:
providing a first signal indicative of a first orientation of a mobile device to a gesture detector,
providing a second signal indicative of a second orientation of said mobile device to said gesture detector, and
providing a control signal based at least on said first signal and said second signal.

20. The method according to claim 19, further comprising providing at least a movement signal indicative of at least a first movement of said mobile device.

21. The method according to claim 19, wherein said control signal is configured to activate at least a first component of said mobile device.

22. The method according to claim 19, wherein said first component is a light for illuminating a display of said mobile device.

23. The method according to claim 19, wherein said control signal is configured to deactivate at least a first component of said mobile device.

24. The method according to claim 19, wherein said first orientation and said second orientation comprise a predefined gesture.

25. The method according to claim 24, wherein said predefined gesture is user defined.

26. The method according to claim 20, wherein said control signal is based at least in part on said movement signal.

27. The method according to claim 19, wherein said control signal is provided during an idle-state of said mobile device.

28. The method according to claim 19, wherein said control signal is provided when at least one user input device of said mobile device is inactivated.

29. The method according to claim 19, further comprising detecting said first orientation of said mobile device, and
detecting said second orientation of said mobile device.

30. The method according to claim 19, further comprising providing an indication to a user of said mobile device based at least in part on said control signal;
wherein said indication corresponds to at least said first orientation of the mobile device.

31. A computer program product comprising a computer readable storage structure embodying computer program code thereon for execution by a computer processor, wherein said computer program code comprising instructions for performing a method comprising:
providing a first signal indicative of a first orientation of a mobile device,
providing a second signal indicative of a second orientation of said mobile device, and.
providing a control signal based at least on said first signal and said second signal.
